(19) United States
(12) Patent Application Publication
(10) Pub. No.: US 2021/0106050 A1
(43) Pub. Date: Apr. 15, 2021

(54) CANDY WITH HOLDER FOR SMOKING ARTICLE

(71) Applicant: Heavenly Smoke-A-Pop LLC, MILWAUKIE, OR (US)

(72) Inventor: Alex Day, Milwaukie, OR (US)

(73) Assignee: Heavenly Smoke-A-Pop LLC, MILWAUKIE, OR (US)

(21) Appl. No.: 16/600,427

(22) Filed: Oct. 11, 2019

(51) Int. Cl. A24F 13/08; A24F 13/12; A24F 7/00; A23G 3/34

(52) U.S. Cl. CPC A24F 13/08; A23G 3/343; A24F 7/00; A24F 13/12

(57) ABSTRACT

Disclosed herein are holders of smoking articles that have an external candy attached so that a user can avoid the harmful effects tied to vaping with e-cigarettes, while simultaneously inhaling unadulterated smoke and enjoy an enhanced flavoring from the candy.

### FIELD OF THE INVENTION

The invention pertains to the field of holders for smoking articles, such as cigarettes and cigars. More particularly, the invention relates to an improved holder for smoking articles that allows for an external candy to be enjoyed while smoking.

### BACKGROUND

Vaping has become popular as it allows users to experience new and interesting flavors through vaporizers or e-cigarettes. Vaping involves heating a vaping oil within a handheld battery-powered vaporizer or e-cigarette to create an aerosol that a user inhales, instead of traditional smoke. Unfortunately, many mysterious illnesses and deaths have recently been linked directly to vaping. Currently scientists do not understand the particular reasons as to why vaping is causing these illness. It is unclear if the illnesses are a result of the chemicals in the vaping oil, the vaporization process itself, or a combination of both. In general, these vaping-linked illnesses have not been substantively studied.

Accordingly, there is a need in the art to allow smokers to add flavor to a traditional smoking article without utilizing vaping oils imbedded within the smoking article or otherwise using an e-cigarette to vaporizing these oils.

### SUMMARY

Various aspects of the invention are enumerated in the following paragraphs. Preferred embodiments are directed to a smoking article holder comprising an external surface, an internal channel, and a distal section and proximal section separated by an external candy; wherein the distal section comprises a distal opening at a distal end configured to receive a smoking article and the proximal section comprises a proximal opening at a proximal end configured to allow smoke from the smoking article to be inhaled by a user, and the internal channel traverses the entire length of the holder from the distal opening to the proximal opening, and has at least a section that tapers from the distal opening in the proximal direction at a length sufficient to wedge the received smoking article by friction.

A method of smoking comprising providing a smoking article holder comprising an external surface, an internal channel, and a distal section and proximal section separated by an external candy; wherein the distal section comprises a distal opening at a distal end configured to receive a smoking article and the proximal section comprises a proximal opening at a proximal end configured to allow smoke from the smoking article to be inhaled by a user, and the internal channel traverses the entire length of the holder from the distal opening to the proximal opening, and has at least a section that tapers from the distal opening in the proximal direction at a length sufficient to wedge the received smoking article by friction; providing a smoking article having a proximal and distal end; inserting the proximal end of the smoking article into the distal opening until it wedges within the taper of the internal channel; placing the user's lips on the outside of the candy, such that the proximal opening of the smoking article holder is also within the user's mouth; lighting the distal end of the smoking article; and inhaling the smoke from the lit smoking article while their lips are on the outside of the candy.

A method of making a smoking article holder, comprising providing a smoking article holder comprising an external surface, an internal channel, and a distal section and proximal section separated by an external candy; wherein the distal section comprises a distal opening at a distal end configured to receive a smoking article and the proximal section comprises a proximal opening at a proximal end configured to allow smoke from the smoking article to be inhaled by a user, and the internal channel traverses the entire length of the holder from the distal opening to the proximal opening, and has at least a section that tapers from the distal opening in the proximal direction at a length sufficient to wedge the received smoking article by friction; providing a first mold having a first and second recessed area; the first recessed area configured in the shape of the smoking article holder and a second recessed area being deeper and wider than the first recessed area, and configured to be in the desired shape of the candy and that divides the first recessed area into proximal and distal sections; placing the smoking article holder into the first recessed area of the mold; pouring a liquid version of candy into the second recessed area of the mold while the smoking article holder is in the first recessed area; and allowing the candy to harden and affix around the smoking article holder and removing the candy and smoking article holder from the mold.

### BRIEF DESCRIPTION OF THE FIGURES

FIG. 1 is a perspective view of a smoking article holder with a spherical-shaped candy.

FIG. 2 is a perspective view of a smoking article holder with a disc-shaped candy.

FIG. 3 is a perspective view of a mold to make the smoking article holder with spherical candy.

FIG. 4 is a perspective view of a smoker using the smoking article holder with candy.

FIG. 5 is a perspective view of the candy with internal passage.

FIG. 6 is a perspective view of a machine-rolled cigarette inserted into the holder with a spherical-shaped candy.

FIG. 7 is a perspective view of a hand-rolled cigarette inserted into the holder with a spherical-shaped candy.

FIG. 8 is a perspective view of the smoking article holder without candy.

### DETAILED DESCRIPTION OF THE INVENTION

The present invention provides a smoking article holder with an external candy piece to allow the smoker to experience an enhanced flavor experience without the dangers associated with vaping and/or vaping oils.

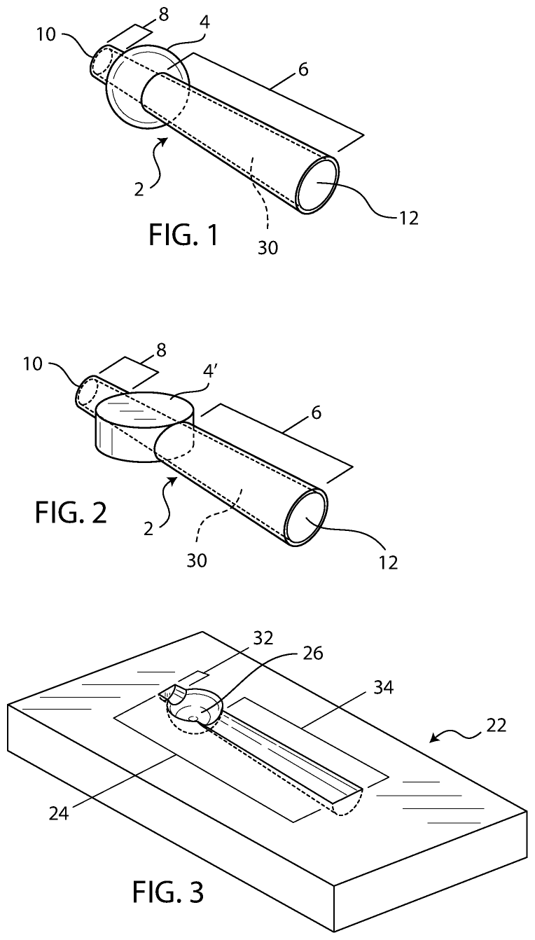

According to preferred embodiments, and as shown in FIG. 1, the smoking article holder 2 provided herein includes a distal section 6 and a proximal section 8 that are separated by a piece of external candy 4. The distal section 6 of the holder 2 begins at a far aperture 16 of the candy 4 and terminates with a distal opening 12 configured to receive the proximal end of a smoking article 20. Preferred lengths of the distal section 6 include 1.5 inches-5 inches. The distal section 6 is configured to have space for the user 28 to secure the holder 2 with their hand, such as pinching the area with their thumb and one or more fingers, so as to avoid touching the candy 4 or the smoking article 20. The proximal section 8 of the holder 2 begins at the near aperture 18 of the candy 4 and terminates at the proximal opening 10, which is configured to allow smoke to be inhaled by the user 28. Preferred lengths of the proximal section 8 include between 1/16- 3/16 inches. The distal opening 12 of the holder 2 connects, via an internal channel 30, to the proximal opening 10, and is configured to allow smoke from a smoking article 20 to travel in a proximal direction into a user's mouth 28. The distal opening 12 preferably is circular in shape and has an internal diameter between ¼ inches-¾ inches, or an area of about 0.2 inches-1.8 square inches, and can be configured to accommodate different types of smoking articles, such as machined-rolled cigarettes, hand-rolled cigarettes, and smaller cigars. According to preferred embodiments, E-cigarettes or vaping pens are not designed to be used with the teachings herein. The proximal opening 10 is preferably smaller than the distal opening 12 and can have an inside diameter of between ⅛ inches-½ inches, or an area of about 0.05-0.8 square inches. The proximal opening is preferably circular, but can include other suitable shapes, such as oval, rectangular, star, and square, for example.

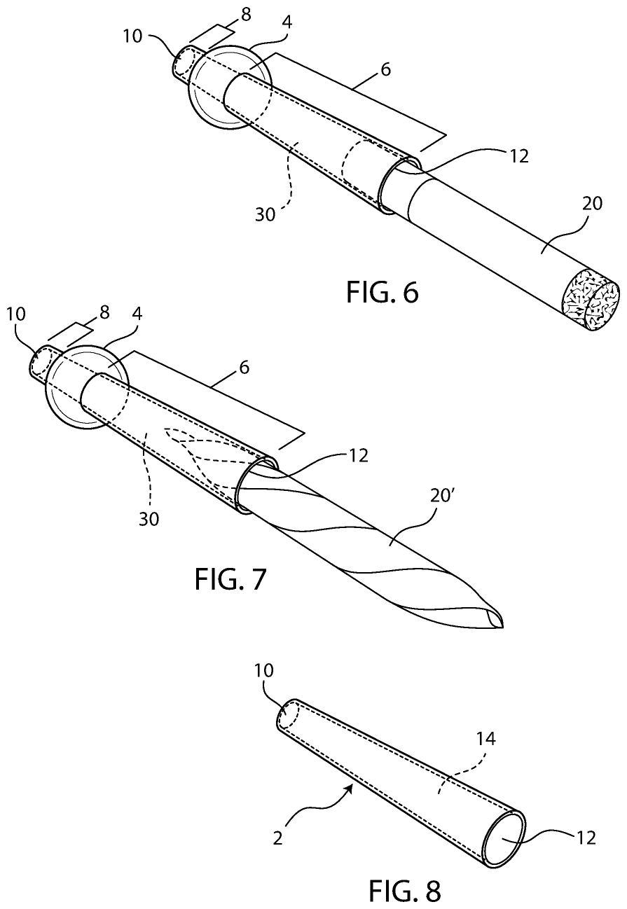

According to the preferred embodiments, and as shown in FIG. 8, the entire smoking article holder 2 and internal channel 30 are both tapered from the distal opening 12 to the proximal opening 10. According to more specific embodiments, the taper of the holder 2 and internal channel 30 are linear. This embodiment gives the holder 2 the shape of a hollowed, truncated cone. Alternatively, the holder is not tapered, and is configured as a different shape, such as a cylinder, for example, and only the internal channel 30 is tapered. The taper of the internal channel 30 allows for a smoking article 20 to be wedged into it and thus be secured by friction. According to other embodiments the taper is only partial within the internal channel 30 and does not traverse the entire length of the holder 2, such that it terminates within the distal section 6 after 0.4-3″ from the distal opening 12, for example. In all embodiments, it is preferred that the taper of the internal channel 30 is configured to wedge the butt/filtration zone of a typical machine-rolled cigarette, such that a portion of the butt/filtration zone is still exposed from the distal opening 12, such as shown in FIG. 6. As most butts/filtration zones are between 20-30 mm long, the taper should wedge the smoking article 30 at a position less than 20-30 mm, measured proximally from the distal opening 12. One preferred distance range includes 18-28 mm from the distal opening 12. Stated otherwise, it is preferred that only about 18-28 mm of the smoking article 20 is wedged into the internal channel 30, leaving the rest of the smoking article 20 exposed and projecting distally from the distal opening 12 of the holder 2. According to more specific embodiments, it is preferred that the taper configuration allows the tobacco rod portion of a machine-rolled cigarette to be completely exposed from the distal opening 12. For hand-rolled smoking articles 20′, such as shown in FIG. 7, the above-stated dimension ranges are also preferred, such that only about 18-28 mm of the hand-rolled smoking article 20′ is wedged within the internal channel 30, leaving the rest of the smoking article 20′ exposed distally.

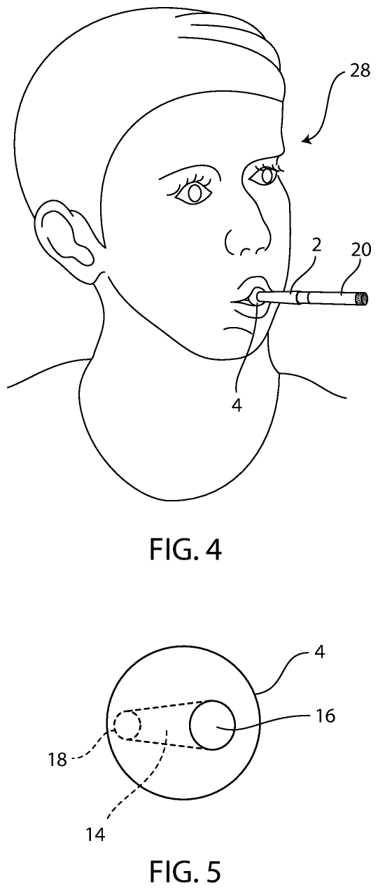

The holder 2 by itself (FIG. 8) is preferably about 2-7 inches in length, measured from the proximal opening 10 to the distal opening 12, while the candy can have a length of about ⅛ inch-3 inches, preferably ¼ inch-2 inches. According to certain embodiments, especially for hand-rolled cigarettes 20′, the internal channel 30, can have an internal screen or filter to prevent ash or other materials besides smoke from entering the user's 28 mouth. According to preferred embodiments, while the external candy 4 has a flavor to allow the user to enhance the smoking experience there are no flavorings in the internal screen or filter, or otherwise in the internal channel 30. Additionally, the smoking article holder 2 preferably lacks flavors in of itself (e.g., a flavored based paper product) such as on its external surface, as well, such that the only flavor the user experiences is directly from the smoke of the smoking article and the external candy 4. The candy 4 can be any desired flavor, such as lemon, menthol, cinnamon, apple, cherry, chocolate, mint, etc. According to some embodiments, the candy 4 does not include any artificial colors and/or flavors, and can be organic. According to even more specific embodiments, it is preferred that no flavoring material, whether oil, resin, or chemicals, etc, is positioned directly in line with the smoke inhalation through the internal channel 30. In light of the recent vaping health issues, the holder 2 described herein has no flavored internal filter or capsule to interfere with the unadulterated smoke from the smoking article 20. The teachings herein are configured to allow the user 28 to place their lips directly on the candy 4 and inhale the smoke directly in a proximal direction, without allowing the candy 4, or any other flavoring, to impede the inhalation of smoke through the internal channel 30, as shown in FIG. 4.

According to further embodiments, the holder can include a small hole or “carb” to allow the user to control airflow while smoking. Additionally, the holder can include logos or decorative elements, such as printing effects.

The smoking article holder 2 can be configured for multiple uses by being made of a material such as metal, glass, silicon, or plastic. Alternatively, the holder 2 can be configured to be disposal such as for a single-use, and be made of disposable material such as a paper-based material, non-exclusively including cardboard, or waxed paper, or a plastic material, for example. Preferred embodiments encompass the holder 2 being entirely made of the same material, but can also be a combination of two or more materials as well.

The candy 4 is positioned on the outside of the holder 2, in between the proximal section 8 and the distal section 6 of the holder 2. Any suitable candy 4 can be used with the teachings herein, such as chocolate or gummy based candies, but preferably the candy is a hard candy, made of the same or similar base materials as a sucker/lollipop or a candy cane. A hard candy, or boiled sweet, is typically a sugar candy prepared from one or more sugar-based syrups that is boiled to make it. Most hard candy is nearly 100% sugar by weight, with a tiny amount of other ingredients for color or flavor, and negligible water content in the final product. Recipes for hard candy may use syrups of sucrose, glucose, fructose or other sugars, such as corn syrup. Sugar-free versions of hard candy can also be used with the teachings herein.

Similarly, any suitable shape of candy can be used. FIGS. 1, 4, 5-7 show a preferred spherical candy shape 4, but FIG. 2 also shows a disc/hockey-puck shaped candy 4′ that can be utilized with all teachings herein. Other shapes of candy, non-exclusively including rectangular, square, animal-shaped, and oval, for example, can likewise be used.

As shown in FIG. 5, the candy 4 has a far aperture 16 that connects, via an internal passage 14, to a near aperture 18, and is configured to allow passage of the holder 2 through the candy 4. The taper of the candy's internal passage 14 is preferably configured to be the same, or substantially the same, as the taper of the outside of the holder 2. For non-preferred embodiments where the outside surface of the holder 2 within the candy is not tapered, such as a cylinder-shape, it is preferred that the internal passage 14 of the candy 4 is likewise not tapered, and more preferably the same shape and/or slope as the outside of the holder 2.

According to preferred embodiments, the candy 4 is affixed to the holder 2. Preferred methods of affixing the candy 4 to the holder 2 include setting the holder 2 (see FIG. 8) into a correspondingly shaped cut-out 24 in a mold 22, such as shown in FIG. 3. More specifically, a first mold 22 having a first and second recessed areas; the first recessed area 24 configured in the shape of the smoking article holder 2 and a second recessed area 26 being deeper and wider than the first recessed area, and configured to be in the desired shape of the candy 4, and that divides the first recessed area 24 into a proximal section 32 and distal section 34. The mold 22 can be made of any suitable material such as silicone, metal, or plastic. The mold 22 preferably includes a candy-shaped cut-out 26 as well, that is more deeply recessed than the holder shaped cut-out 24. While shown as spherical, the candy-shaped cut-out can be any shape the manufacturer desires the candy to be, non-exclusively including disc-shaped, rectangular, square, oval, etc. The candy can be in a heated, liquid state and poured into its recessed area 26 while the holder 2 is resting in its respective recessed area 24. A second mold piece that is the same, or substantially similar, to the first mold 22 is preferably placed on top of the first mold piece during setting. The second and first mold pieces 22 can be detached from each other or hinged together for ease of use. According to non-preferred embodiments, only the first mold 22 is used such that the hardened candy is either irregularly shaped and/or only wraps around part of the holder 2.

Preferably, the liquid candy is allowed to harden into a solid state onto the holder 2 within the mold 22, and the holder 2 and resulting candy 4 are removed afterwards to undergo packaging and sale. Any suitable wrapping can be used to cover the holder 2 and/or candy 4 product, non-exclusively including, cardboard, cellophane, other thin plastic wrap, or waxed paper, for example. The above-described process can work for non-hard candies, such as chocolate and gummy type candy as well.

1. A smoking article holder comprising: an external surface, an internal channel, and a distal section and proximal section separated by an external candy; wherein the distal section comprises a distal opening at a distal end configured to receive a smoking article and the proximal section comprises a proximal opening at a proximal end configured to allow smoke from the smoking article to be inhaled by a user, and the internal channel traverses the entire length of the holder from the distal opening to the proximal opening, and has at least a section that tapers from the distal opening in the proximal direction at a length sufficient to wedge the received smoking article by friction.

2. The smoking article holder of claim 1, wherein the entire internal channel linearly tapers from the distal opening to the proximal opening.

3. The smoking article holder of claim 1, wherein the candy has a far aperture and a near aperture connected by an internal passage, wherein the internal passage is configured to allow passage of the smoking article through the internal passage, such that the proximal section extends proximally from the near aperture and the distal extends distally from the far aperture.

4. The smoking article holder of claim 3, wherein the internal passage of the candy and the external surface of the smoking article holder taper from the distal opening to the proximal opening.

5. The smoking article holder of claim 1, wherein the smoking article holder is in the shape of a truncated cone.

6. The smoking article holder of claim 1, wherein the external surface and the internal passage lack any flavoring chemicals.

7. The smoking article holder of claim 1, wherein the entire length of the holder, measured from the proximal opening to the distal opening, is between 2-7 inches, the proximal opening has an area of between ⅛-0.5 square inches, and the distal opening has an area of between 0.2-1.8 square inches.

8. The smoking article holder of claim 7, wherein the proximal segment is between 1/16- 3/16 inches and the distal segment is between 1.5-5 inches.

9. A method of smoking comprising:
a) providing a smoking article holder comprising an external surface, an internal channel, and a distal section and proximal section separated by an external candy; wherein the distal section comprises a distal opening at a distal end configured to receive a smoking article and the proximal section comprises a proximal opening at a proximal end configured to allow smoke from the smoking article to be inhaled by a user, and the internal channel traverses the entire length of the holder from the distal opening to the proximal opening, and has at least a section that tapers from the distal opening in the proximal direction at a length sufficient to wedge the received smoking article by friction;
b) providing a smoking article having a proximal and distal end; inserting the proximal end of the smoking article into the distal opening until it wedges within the taper of the internal channel;
c) placing the user's lips on the outside of the candy, such that the proximal opening of the smoking article holder is also within the user's mouth;
d) lighting the distal end of the smoking article; and
e) inhaling the smoke from the lit smoking article while their lips are on the outside of the candy.

10. The method of claim 9, wherein the external surface and the internal passage of the smoking article holder lack any flavoring chemicals.

11. The method of claim 9, wherein the entire length of the smoking article holder, measured from the proximal opening to the distal opening, is between 2-7 inches, the proximal opening has an area of between ⅛-0.5 square inches, and the distal opening has an area of between 0.2-1.8 square inches.

12. The method of claim 11, wherein the proximal segment of the smoking article holder is between 1/16- 3/16 inches and the distal segment of the smoking article holder is between 1.5-5 inches.

13. A method of making a smoking article holder, comprising:
a) providing a smoking article holder comprising an external surface, an internal channel, and a distal section and proximal section separated by an external candy; wherein the distal section comprises a distal opening at a distal end configured to receive a smoking article and the proximal section comprises a proximal opening at a proximal end configured to allow smoke from the smoking article to be inhaled by a user, and the internal channel traverses the entire length of the holder from the distal opening to the proximal opening, and has at least a section that tapers from the distal opening in the proximal direction at a length sufficient to wedge the received smoking article by friction;
b) providing a first mold having a first and second recessed area; the first recessed area configured in the shape of the smoking article holder and a second recessed area being deeper and wider than the first recessed area, and configured to be in the desired shape of the candy and that divides the first recessed area into proximal and distal sections;
c) placing the smoking article holder into the first recessed area of the mold;
d) pouring a liquid version of candy into the second recessed area of the mold while the smoking article holder is in the first recessed area; and
e) allowing the candy to harden and affix around the smoking article holder and afterwards removing the candy and smoking article holder from the mold.

14. The method of claim 13, further comprising providing a second mold having the same configuration as the first mold; and placing the second mold on top of the first mold during the hardening process.

15. The method of claim 14, wherein the first and second molds are hinged together.

16. The method of claim 13, wherein the first recessed area is in the shape of a truncated cone.

17. The method of claim 13, wherein the first recessed area is in the shape of a cylinder.

18. The method of claim 13, wherein the external surface and the internal passage of the smoking article holder lack any flavoring chemicals.

19. The method of claim 13, wherein the entire length of the smoking article holder, measured from the proximal opening to the distal opening, is between 2-7 inches, the proximal opening has an area of between ⅛-0.5 square inches, and the distal opening has an area of between 0.2-1.8 square inches.

20. The method of claim 19, wherein the proximal segment of the smoking article holder is between 1/16- 3/16 inches and the distal segment of the smoking article holder is between 1.5-5 inches.
